(19) United States
(12) Patent Application Publication
(10) Pub. No.: US 2011/0268921 A1
(43) Pub. Date: Nov. 3, 2011

(54) DECORATIVE RESIN-BASED PANELS

(76) Inventors: Jill A. Canales, Salt Lake City, UT (US); Guillaume Martin, Rochetoirin (FR); Michael Damen, Rochetoirin (FR); Elizabeth Egan Metcalf, Salt Lake City, UT (US); Baltasar D. McMaster, Salt Lake City, UT (US)

(21) Appl. No.: 12/806,191

(22) Filed: May 3, 2010

(51) Int. Cl. B32B 3/30; B32B 27/06; B32B 27/10

(52) U.S. Cl. 428/156; 442/181

(57) ABSTRACT

Decorative resin-based panels that provide desirable aesthetics that a designer can use to add to the functional and/or aesthetic characteristics of a given structure or design space. The decorative resin-based panels include one or more of embossed surfaces, fabric interlayers, handmade paper interlayers, spun yarn interlayers, and squared cores.

### CROSS-REFERENCE TO RELATED APPLICATIONS

NA.

### BACKGROUND OF THE INVENTION

1. The Field of the Invention

Implementations of the present invention relate to decorative resin lighting fixtures.

2. Discussion of the Relevant Art

Recent trends in building design involve adding to the functional and/or aesthetic characteristics of a given structure or design space by mounting one or more sets of decorative panels thereto. In particular, the use of resin materials is becoming increasingly popular in sculptural and lighting applications. In general, resin materials such as these are now popular compared with decorative cast or laminated glass materials, since resin materials may be manufactured to be more resilient and to have a similar transparent, translucent, or decorative appearance as cast or laminated glass, but with less cost. Decorative resins can also provide more flexibility compared with glass at least in terms of color, degree of texture, gauge, impact resistance, and ease of fabrication.

### BRIEF SUMMARY OF THE INVENTION

Implementations of the present invention provide decorative resin-based panels that provide desirable aesthetics that a designer can use to add to the functional and/or aesthetic characteristics of a given structure or design space. For example, one or more implementations of the present invention include resin-based panels with an embossed surface. One or more additional implementations of the present invention include laminated resin-based panels having a decorative image layer of decorative fabric, handmade paper, or spun yarn. One or more further implementations of the present invention include resin-based panels having squared cores.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a photograph showing a front view of a resin-based panel with an embossed channel design in accordance with an implementation of the present invention;

FIG. 2 is a photograph showing a back view of the resin-based panel with an embossed line design of FIG. 1;

FIG. 3 is a photograph showing a top view of the resin-based panel with an embossed channel design of FIG. 1;

FIG. 4 is a photograph showing a bottom view of the resin-based panel with an embossed channel design of FIG. 1;

FIG. 5 is a photograph showing a right-side view of the resin-based panel with an embossed channel design of FIG. 1;

FIG. 6 is a photograph showing a left-side view of the resin-based panel with an embossed channel design of FIG. 1;

FIG. 7 is a photograph showing a partition formed from curved resin-based panels with embossed channel designs in accordance with an implementation of the present invention;

FIG. 8 is a photograph showing a front view of a resin-based panel with an embossed pebble design in accordance with an implementation of the present invention;

FIG. 9 is a photograph showing a back view of the resin-based panel with an embossed pebble design of FIG. 8;

FIG. 10 is a photograph showing a top view of the resin-based panel with an embossed pebble design of FIG. 8;

FIG. 11 is a photograph showing a bottom view of the resin-based panel with an embossed pebble design of FIG. 8;

FIG. 12 is a photograph showing a right-side view of the resin-based panel with an embossed pebble design of FIG. 8;

FIG. 13 is a photograph showing a left-side view of the resin-based panel with an embossed pebble design of FIG. 8;

FIG. 14 is a photograph showing a partition formed from a resin-based panel with an embossed pebble design in accordance with an implementation of the present invention;

FIG. 15 is a photograph showing a front view of a resin-based panel with an embossed bubble design in accordance with an implementation of the present invention;

FIG. 16 is a photograph showing a back view of the resin-based panel with an embossed bubble design of FIG. 15;

FIG. 17 is a photograph showing a top view of the resin-based panel with an embossed bubble design of FIG. 15;

FIG. 18 is a photograph showing a bottom view of the resin-based panel with an embossed bubble design of FIG. 15;

FIG. 19 is a photograph showing a right-side view of the resin-based panel with an embossed bubble design of FIG. 15;

FIG. 20 is a photograph showing a left-side view of the resin-based panel with an embossed bubble design of FIG. 15;

FIG. 21 is a photograph showing a partition formed from a resin-based panel with an embossed bubble design in accordance with an implementation of the present invention;

FIG. 22 is a photograph showing a front view of a resin-based panel with a fabric interlayer having a line and bunch design in accordance with an implementation of the present invention;

FIG. 23 is a photograph showing a back view of the resin-based panel with a fabric interlayer having a line and bunch design of FIG. 22;

FIG. 24 illustrates a top section-view of the resin-based panel with a fabric interlayer having a line and bunch design of FIG. 22;

FIG. 25 illustrates a bottom section-view of the resin-based panel with a fabric interlayer having a line and bunch design of FIG. 22;

FIG. 26 illustrates a right-side section-view of the resin-based panel with a fabric interlayer having a line and bunch design of FIG. 22;

FIG. 27 illustrates a left-side section-view of the resin-based panel with a fabric interlayer having a line and bunch design of FIG. 22;

FIG. 28 is a photograph showing a partition formed from a resin-based panel with a fabric interlayer having a line and bunch design in accordance with an implementation of the present invention;

FIG. 29 is a photograph showing a front view of a resin-based panel with a densely woven fabric interlayer having a flowing design in accordance with an implementation of the present invention;

FIG. 30 is a photograph showing a back view of the resin-based panel with a densely woven fabric interlayer having a flowing design of FIG. 29;

FIG. 31 illustrates a top section-view of the resin-based panel with a densely woven fabric interlayer having a flowing design of FIG. 29;

FIG. 32 illustrates a bottom section-view of the resin-based panel with a densely woven fabric interlayer having a flowing design of FIG. 29;

FIG. 33 illustrates a right-side section-view of the resin-based panel with a densely woven fabric interlayer having a flowing design of FIG. 29;

FIG. 34 illustrates a left-side section-view of the resin-based panel with a densely woven fabric interlayer having a flowing design of FIG. 29;

FIG. 35 is a photograph showing a partition formed from a resin-based panel with a densely woven fabric interlayer having a flowing design in accordance with an implementation of the present invention;

FIG. 36 is a photograph showing a front view of a resin-based panel with a handmade paper interlayer having an intertwining design in accordance with an implementation of the present invention;

FIG. 37 is a photograph showing a back view of the resin-based panel with a handmade paper interlayer having an intertwining design of FIG. 36;

FIG. 38 illustrates a top section-view of the resin-based panel with a handmade paper interlayer having an intertwining design of FIG. 36;

FIG. 39 illustrates a bottom section-view of the resin-based panel with a handmade paper interlayer having an intertwining design of FIG. 36;

FIG. 40 illustrates a right-side section-view of the resin-based panel with a handmade paper interlayer having an intertwining design of FIG. 36;

FIG. 41 illustrates a left-side section-view of the resin-based panel with a handmade paper interlayer having an intertwining design of FIG. 36;

FIG. 42 is a photograph showing a partition formed from a resin-based panel with a handmade paper interlayer having an intertwining design in accordance with an implementation of the present invention;

FIG. 43 is a photograph showing a front view of a resin-based panel with an interlayer of spun yarn in a linear formation in accordance with an implementation of the present invention;

FIG. 44 is a photograph showing a back view of the resin-based panel with an interlayer of spun yarn in a linear formation of FIG. 43;

FIG. 45 illustrates a top section-view of the resin-based panel with an interlayer of spun yarn in a linear formation of FIG. 43;

FIG. 46 illustrates a bottom section-view of the resin-based panel with an interlayer of spun yarn in a linear formation of FIG. 43;

FIG. 47 illustrates a right-side section-view of the resin-based panel with an interlayer of spun yarn in a linear formation of FIG. 43;

FIG. 48 illustrates a left-side section-view of the resin-based panel with an interlayer of spun yarn in a linear formation of FIG. 43;

FIG. 49 is a photograph showing a partition formed from a resin-based panel with an interlayer of spun yarn in a linear formation in accordance with an implementation of the present invention;

FIG. 50 is a photograph showing a front view of a resin-based panel with an interlayer of spun yarn in a bisecting formation in accordance with an implementation of the present invention;

FIG. 51 is a photograph showing a back view of the resin-based panel with an interlayer of spun yarn in a bisecting formation of FIG. 50;

FIG. 52 illustrates a top section-view of the resin-based panel with an interlayer of spun yarn in a bisecting formation of FIG. 50;

FIG. 53 illustrates a bottom section-view of the resin-based panel with an interlayer of spun yarn in a bisecting formation of FIG. 50;

FIG. 54 illustrates a right-side section-view of the resin-based panel with an interlayer of spun yarn in a bisecting formation of FIG. 50;

FIG. 55 illustrates a left-side section-view of the resin-based panel with an interlayer of spun yarn in a bisecting formation of FIG. 50;

FIG. 56 is a photograph showing a partition formed from a resin-based panel with an interlayer of spun yarn in a bisecting formation in accordance with an implementation of the present invention;

FIG. 57 is a photograph showing a front view of a resin-based panel having a squared-core in accordance with an implementation of the present invention;

FIG. 58 is a photograph showing a back view of the resin-based panel having a squared-core of FIG. 57;

FIG. 59 is a photograph showing a top view of the resin-based panel having a squared-core of FIG. 57;

FIG. 60 is a photograph showing a bottom view of the resin-based panel having a squared-core of FIG. 57;

FIG. 61 is a photograph showing a right-side view of the resin-based panel having a squared-core of FIG. 57;

FIG. 62 is a photograph showing a left-side view of the resin-based panel having a squared-core of FIG. 57; and

FIG. 63 is a photograph showing a partition formed from resin-based panels having squared-cores in accordance with an implementation of the present invention; and

### DETAILED DESCRIPTION OF THE PREFERRED EMBODIMENTS

The present invention is directed toward decorative resin-based panels that provide desirable aesthetics that a designer can use to add to the functional and/or aesthetic characteristics of a given structure or design space. For example, one or more implementations of the present invention include resin-based panels with an embossed surface. One or more additional implementations of the present invention include laminated resin-based panels having a decorative image layer of decorative fabric, handmade paper, or spun yarn. One or more further implementations of the present invention include resin-based panels having squared cores.

Additionally, decorative resin-based panels of the present invention can provide unique and desirable aesthetics. For example, implementations of decorative resin-based panels can be translucent and allow light transmission there through. Designers can use such translucent decorative resin-based panels in lighting applications, such as light boxes, or as window coverings. Furthermore, the decorative resin-based panels can provide varying degrees transparency/translucency, and thus, varying degrees of privacy. Thus, designers can use decorative resin-based panels of the present invention as partitions, doors, or dividers where varying degrees of privacy are desired. Indeed, designers can use decorative resin-based panels of the present invention as partitions, displays, barriers, treatments, or other structures.

As used herein, the terms “resin-based panel” and “resin panel” refer to panels comprising a substrate of one or more layers or sheets formed from any one of the following thermoplastic polymers (or alloys thereof). Specifically, such materials can include, but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), or the like.

As a preliminary matter, implementations of the present invention are described herein primarily with reference to resin-based panels. One will appreciate, however, that a panel, particularly a resin-based panel, is only one type of “structure” which may include the designs and decorative image layers described herein. For example, a manufacturer can also emboss a decorative image layer into, or laminate a decorative image layer between, not only resin “panels,” as such, but also glass panels or panels of other materials.

For example, FIGS. 1-6 illustrate various views of a resin-based panel with an embossed channel design 100 in accordance with an implementation of the present invention. In particular, FIG. 1 shows a resin-based panel 100 having a plurality of linear channels or groves 102 formed into the front surface thereof. The plurality of linear channels or grooves 102 can extend partially into the resin-based panel 100 from the front surface toward the back surface.

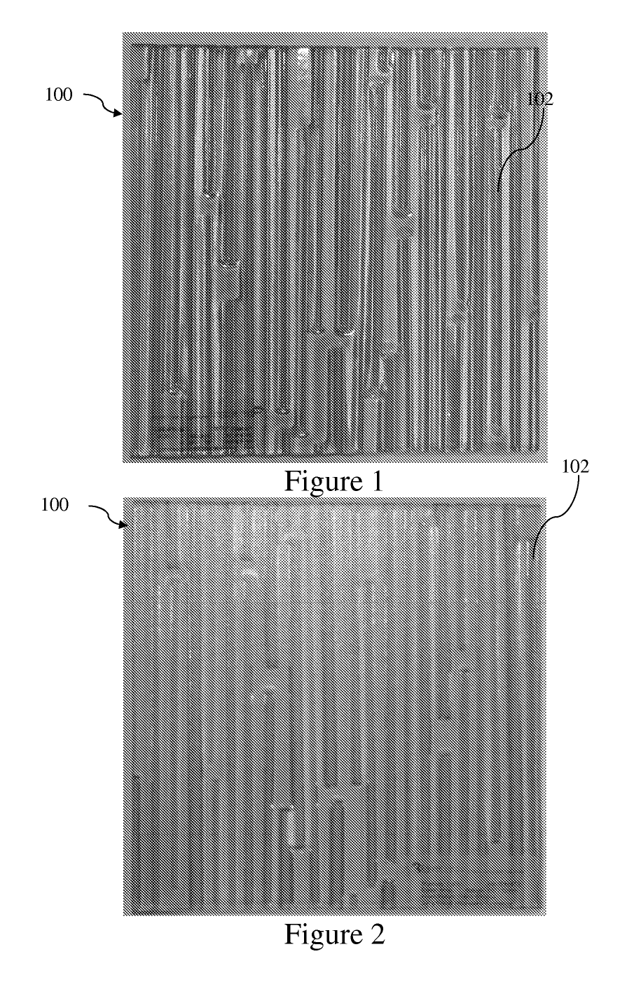

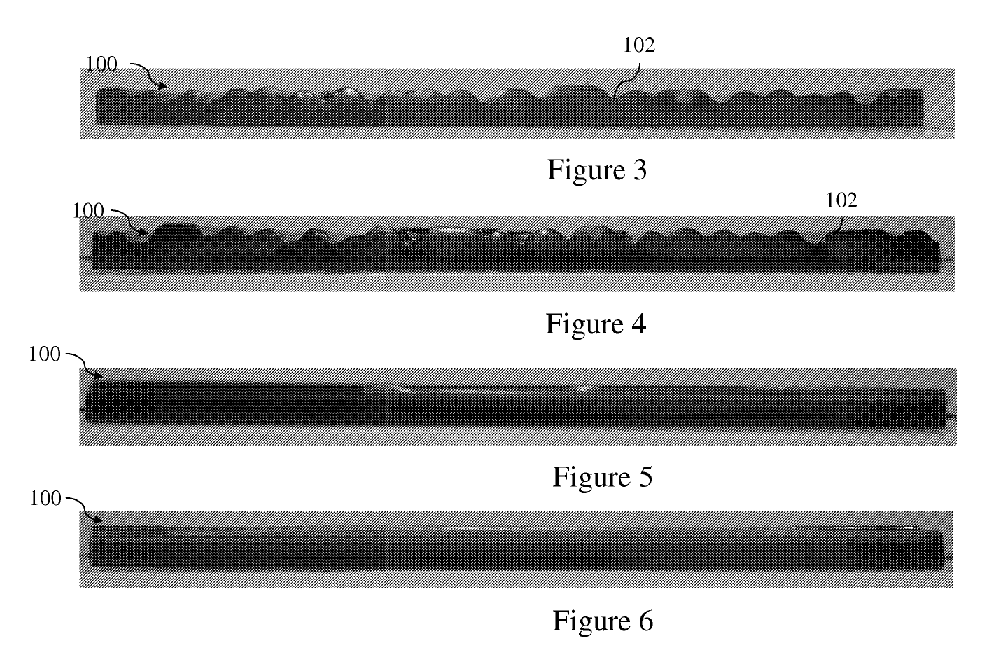

As shown by FIGS. 1 and 2, the channels 102 can extend in substantially parallel directions. Furthermore, FIGS. 3 and 4 illustrate that the channels 102 can have various sizes and various depths. As illustrated by FIGS. 1-6, in some implementations, the back surface of the resin-based panel with an embossed channel design 100 can be planar without embossing. In alternative implementations, both the front and back surface of the resin-based panel with an embossed channel design 100 can include embossing.

In some implementations, the resin-based panel with an embossed channel design 100 can comprise a clear, transparent resin. In such implementations, the resin-based panel with an embossed channel design 100 can include a colored film laminated to the back surface. The colored film can impart a color to the resin-based panel with an embossed channel design 100. In alternative implementations, the resin-based panel with an embossed channel design 100 can comprise a resin-based material that is extruded with color.

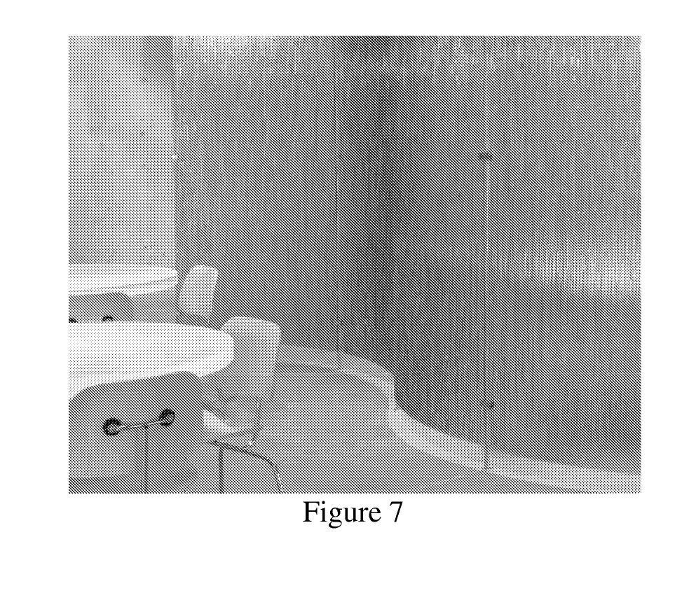

In any event, as shown by FIG. 7, the resin-based panel with an embossed channel design can be at least partially translucent. In alternative implementations, the resin-based panel with an embossed channel design can be transparent or opaque. Additionally, FIG. 7 illustrates that a manufacturer can curve the resin-based panel with an embossed channel design to provide a desirable aesthetic or functional purpose.

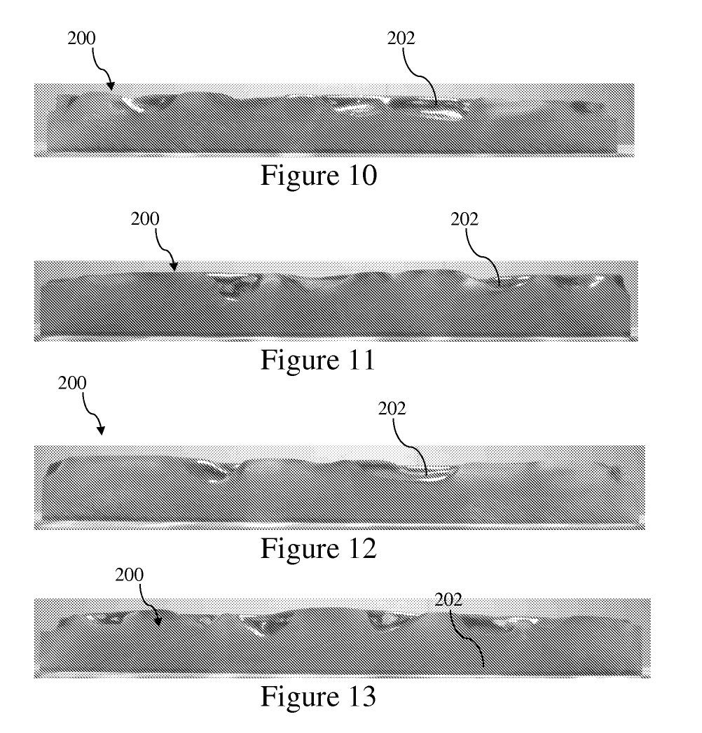

A manufacturer can form the resin-based panel with an embossed channel design by heating a resin substrate above its glass transition temperature, and then pressing a mold or pattern die into one or more surfaces of the resin substrate. The mold can displace softened or melted resin of the substrate thereby creating the channels. In alternative implementations, a manufacturer can heat the mold or pattern die, and then press the heated mold or die into the resin substrate. One will appreciate that a manufacturer can form the other embossed panels described below in reference to FIGS. 8-21 in a like manner.

Referring now to FIGS. 8-13, various views of another resin-based panel with an embossed design 200 are shown. In particular, FIGS. 8-13 show a resin-based panel 200 having a plurality of pebble-shaped depressions 202 formed into the front surface thereof. The plurality of pebble-shaped depressions 202 can extend partially into the resin-based panel 200 from the front surface toward the back surface.

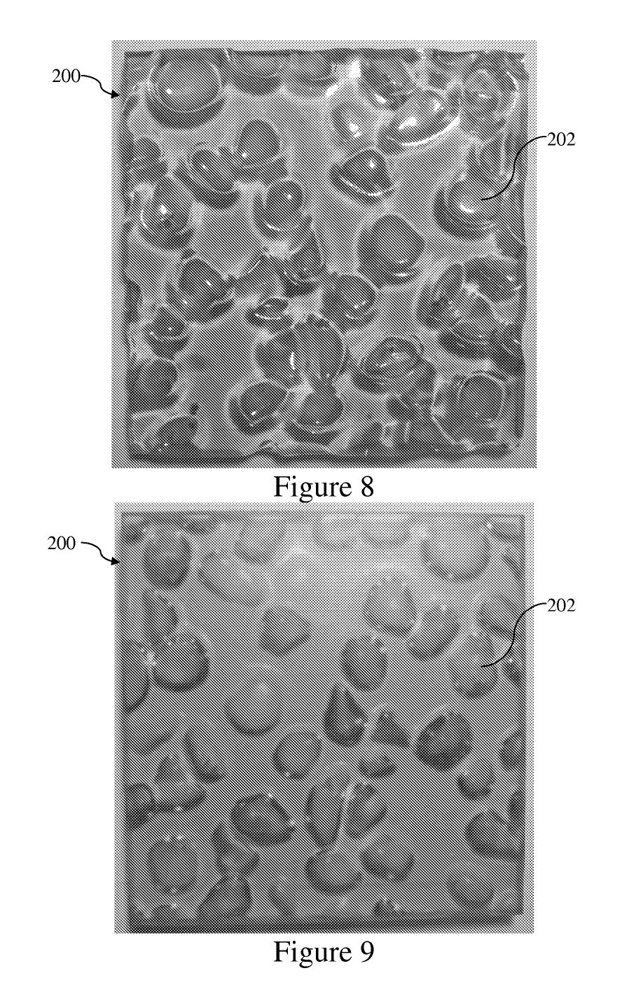

As shown by FIGS. 8 and 9, the depressions 202 can have the shapes of pebbles or stones. Additionally, the pebble-shaped depressions 202 can be oriented in a random pattern. In alternative implementations, the pebble-shaped depressions 202 can be oriented in an organized manner.

FIGS. 10-13 illustrate that the pebble-shaped depressions 202 can have various sizes, shapes, and depths. In some implementations, the back surface of the resin-based panel with an embossed pebble design 200 can be planar without embossing. In alternative implementations, both the front and back surface of the resin-based panel with an embossed pebble design 200 can include embossing.

In some implementations, the resin-based panel with an embossed pebble design 200 can be formed with a clear, transparent resin. In such implementations, the resin-based panel with an embossed pebble design 200 can include a colored film laminated to the back surface. The colored film can impart a color to the resin-based panel with an embossed pebble design 200. In alternative implementations, the resin of the resin-based panel with an embossed pebble design 200 can be extruded with a color.

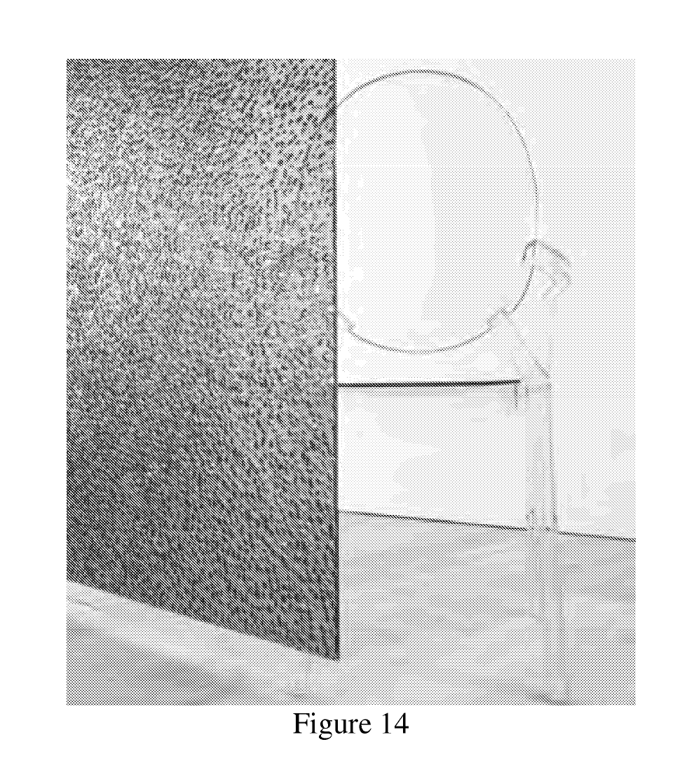

In any event, as shown by FIG. 14, the resin-based panel with an embossed pebble design can be at least partially translucent. In alternative implementations, the resin-based panel with an embossed pebble design can be transparent or opaque. One will appreciate that a manufacturer can use the resin-based panel with an embossed pebble design as a partition as shown in FIG. 14, or other structure.

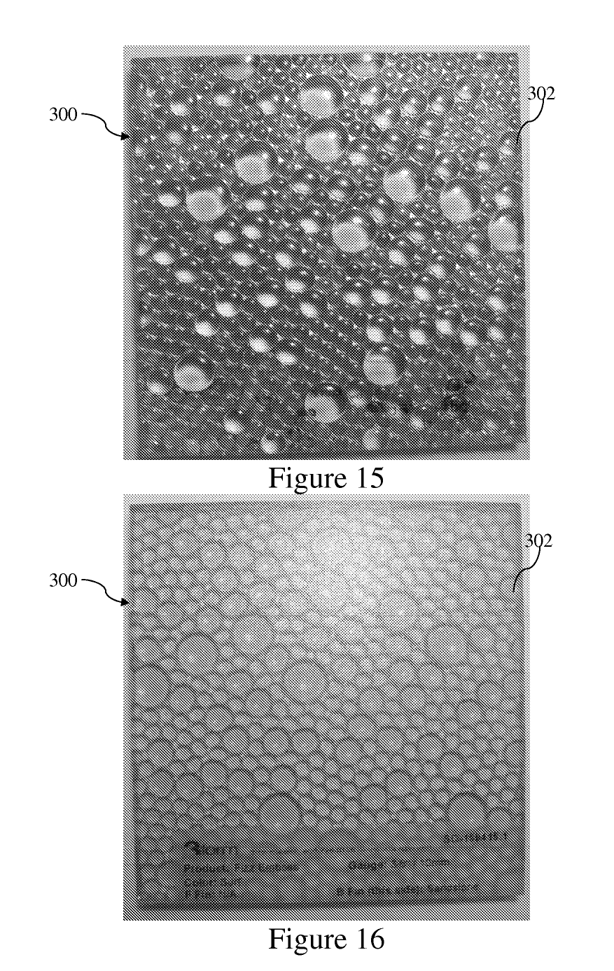

FIGS. 15-20 illustrate various views of another resin-based panel with an embossed design 300 in accordance with yet another implementation. In particular, FIGS. 15-20 show a resin-based panel 300 having a plurality of bubble-shaped depressions 302 formed into the front surface thereof. The plurality of pebble-shaped depressions 302 can extend partially into the resin-based panel 300 from the front surface toward the back surface.

As shown by FIGS. 15 and 16, the depressions 302 can have the shapes of bubbles or circles. Additionally, the bubble-shaped depressions 302 can be oriented in a random pattern. In alternative implementations, the bubble-shaped depressions 302 can be oriented in an organized manner.

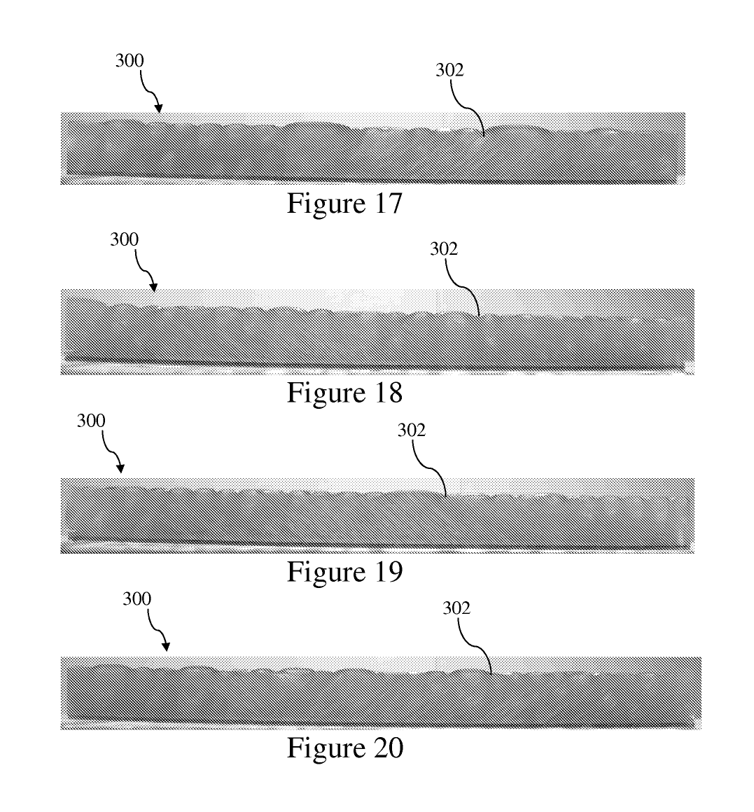

FIGS. 17-20 illustrate that the bubble-shaped depressions 302 can have various sizes, shapes, and depths. Furthermore, the bubble-shaped depressions 302 can include a circle or bubble outline that extends into the front surface of the resin-based panel 300. The embossed circle or bubble outline can create a circle or bubble shape that appears to protrude away from the front surface of the panel 300.

In some implementations, the back surface of the resin-based panel with an embossed bubble design 300 can be planar without embossing. In alternative implementations, both the front and back surface of the resin-based panel with an embossed bubble design 300 can include embossing. In yet further implementations, the front surface can include an embossed bubble design 300, and the back surface can include a different embossed design, such as, for example, a pebble or channel design.

Similar to panels 100 and 200 described above, the resin-based panel with an embossed bubble design 300 can be formed with a clear, transparent resin. In such implementations, the resin-based panel with an embossed bubble design 300 can include a colored film laminated to the back surface. The colored film can impart a color to the resin-based panel with an embossed bubble design 300. In alternative implementations, the resin of the resin-based panel with an embossed bubble design 300 can be extruded with a color.

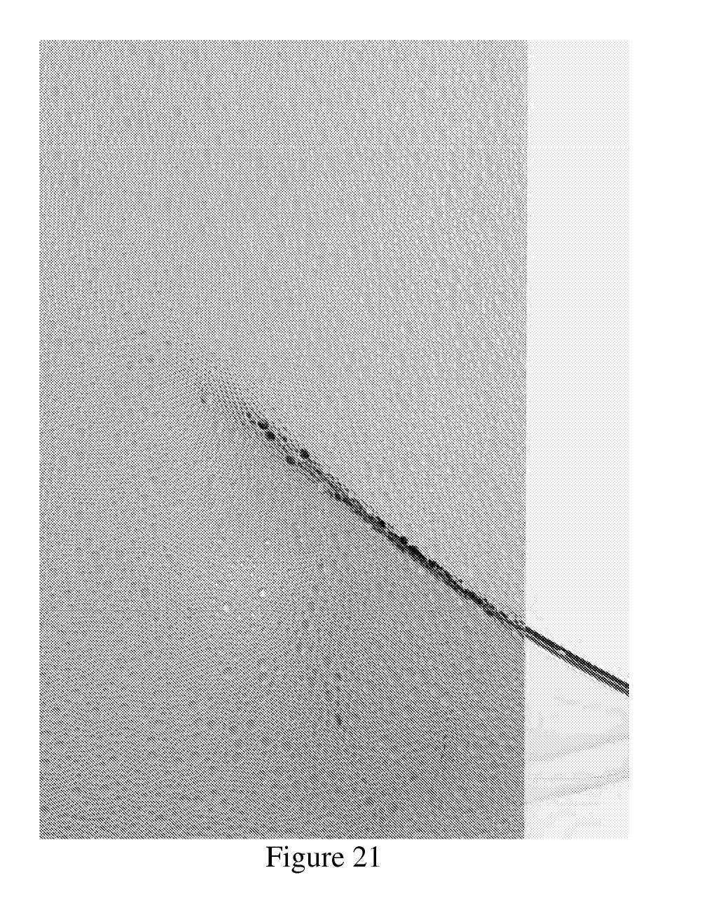

In any case, as shown by FIG. 21, the resin-based panel with an embossed bubble design can be at least partially translucent. In alternative implementations, the resin-based panel with an embossed bubble design can be transparent or opaque. One will appreciate that the resin-based panel with an embossed pebble design can provide varying degrees of privacy.

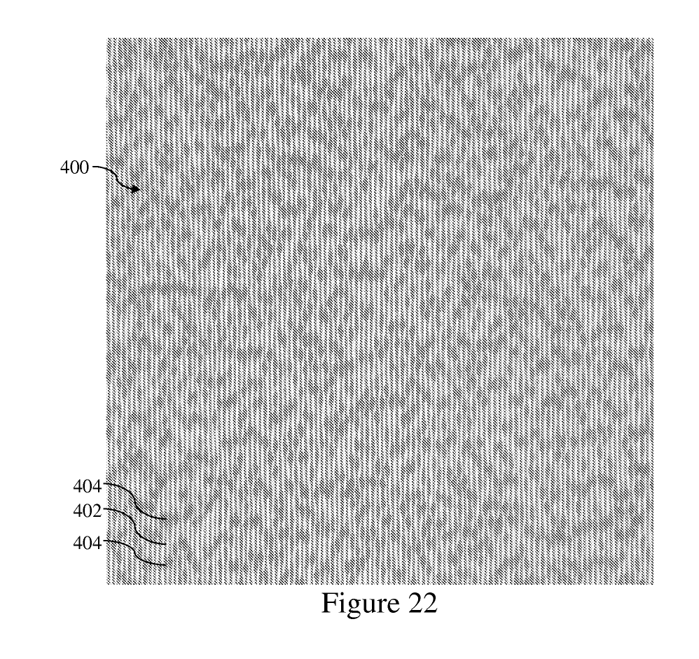

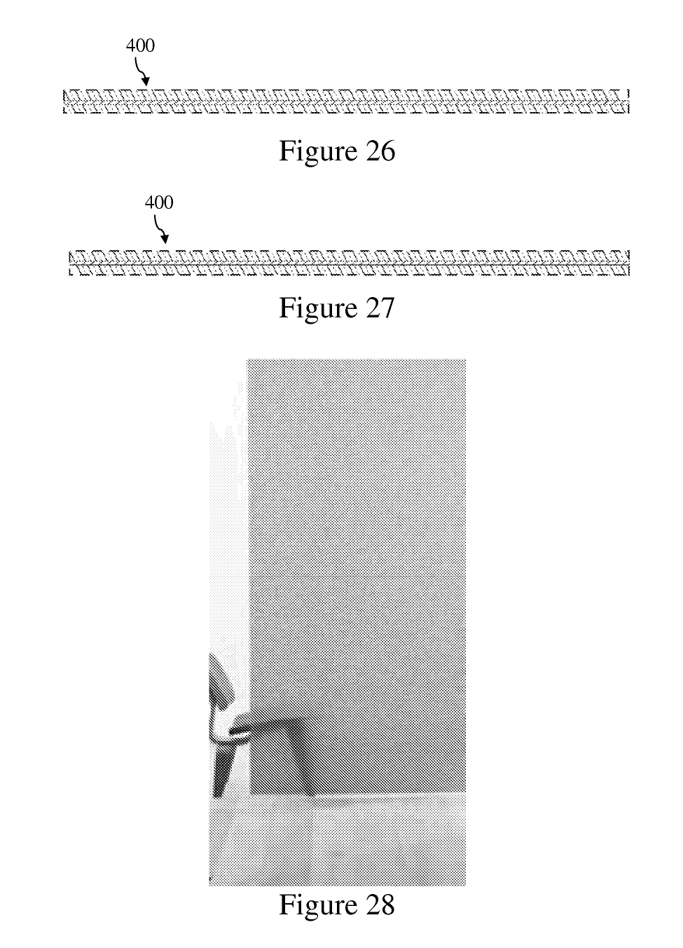

As mentioned previously, panels of the present invention can also include fabric interlayers. For example, FIGS. 22-27 illustrate various views of another resin-based panel with a fabric interlayer 400. In particular, FIGS. 22-27 illustrate a resin-based panel 400 having a fabric interlayer having a line and bunch design 402. In other words, the fabric interlayer 408 can include a linear lines 402 with repeating bunches or clusters of fabric or color 404 spaced out along the linear lines.

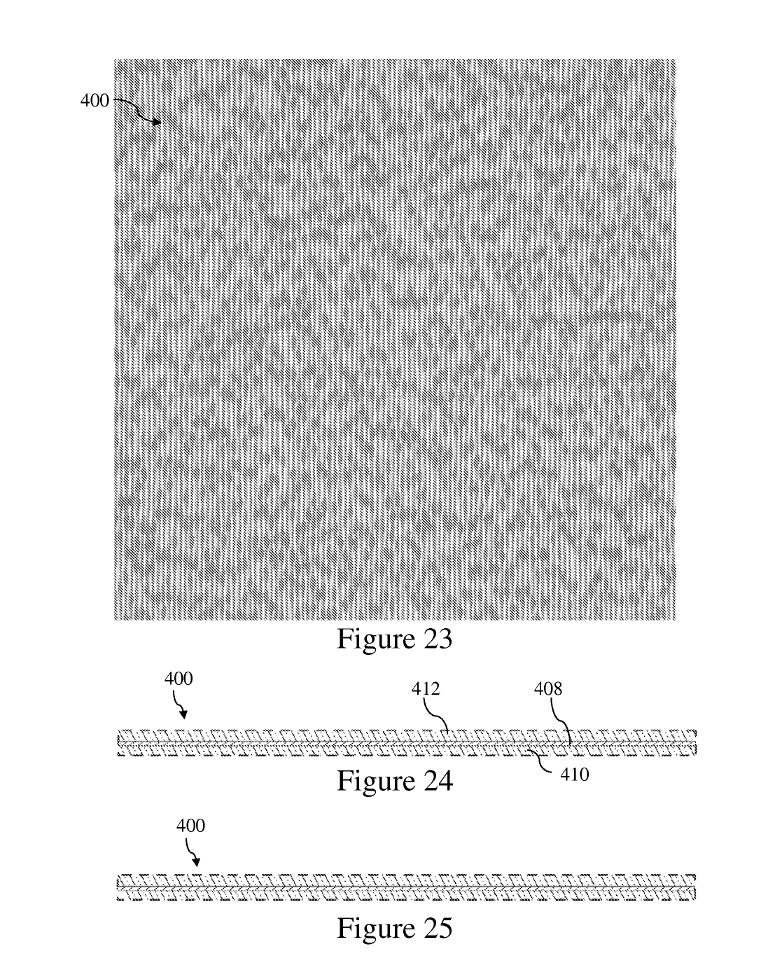

FIGS. 24-27 illustrate that the resin-based panel 400 can include a fabric interlayer 408 having a line and bunch design laminated between opposing resin layers 410, 412. In particular, the opposing resin layers 410, 412 can be melted and adhered to the fabric interlayer having a line and bunch design 408. In some implementations, the opposing resin layers 410, 412 can extend between the fabric of the fabric interlayer 408 and bond to each other.

The resin layers 410, 412 can be transparent, translucent, and/or colored. In alternative implementations one of the resin layers 410, 412 can be opaque. In any event at least one of the resin layers 410, 412 can be at least partially transparent to visually expose the fabric interlayer 408.

One will appreciate that the gauge or thickness of the resin layers 410, 412 and the fabric interlayer 408 can vary depending upon the desired functional and aesthetic use of the resin-based panel 400. For example, FIG. 28 illustrates that the fabric interlayer 408 can have a thickness thin enough so the resulting panel 400 is at least partially translucent. FIG. 28 also shows that a manufacturer can use the resin-based panel 400 with fabric interlayer having a line and bunch design 408 as part of a partition or other structure.

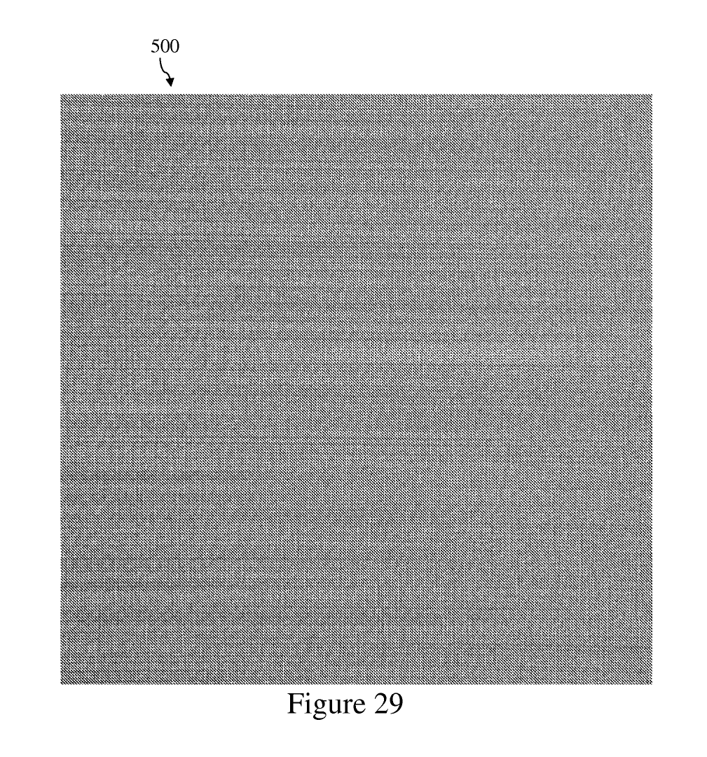

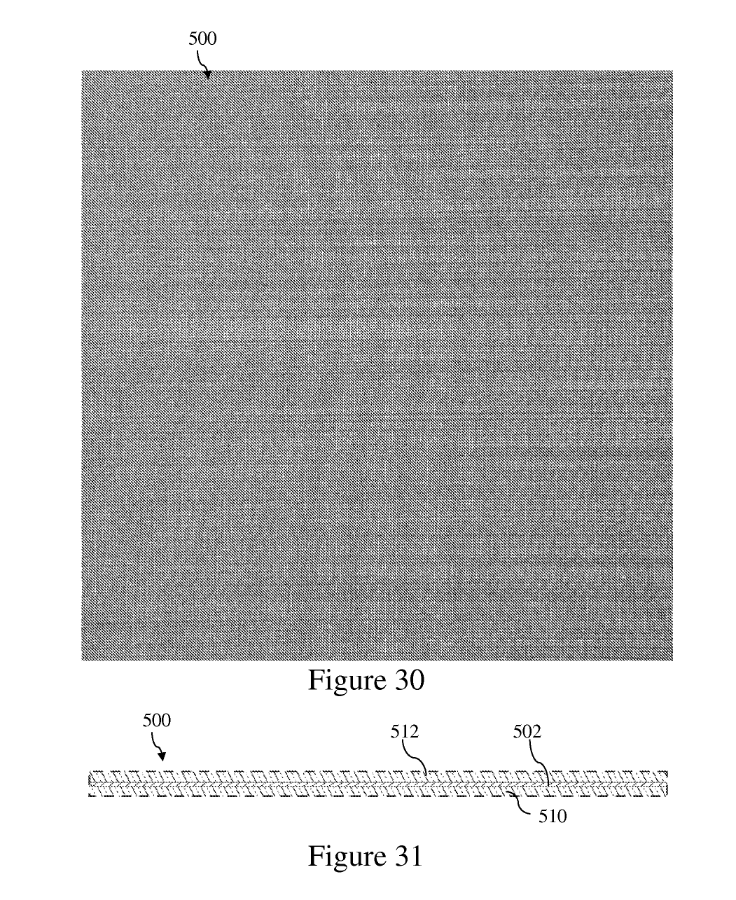

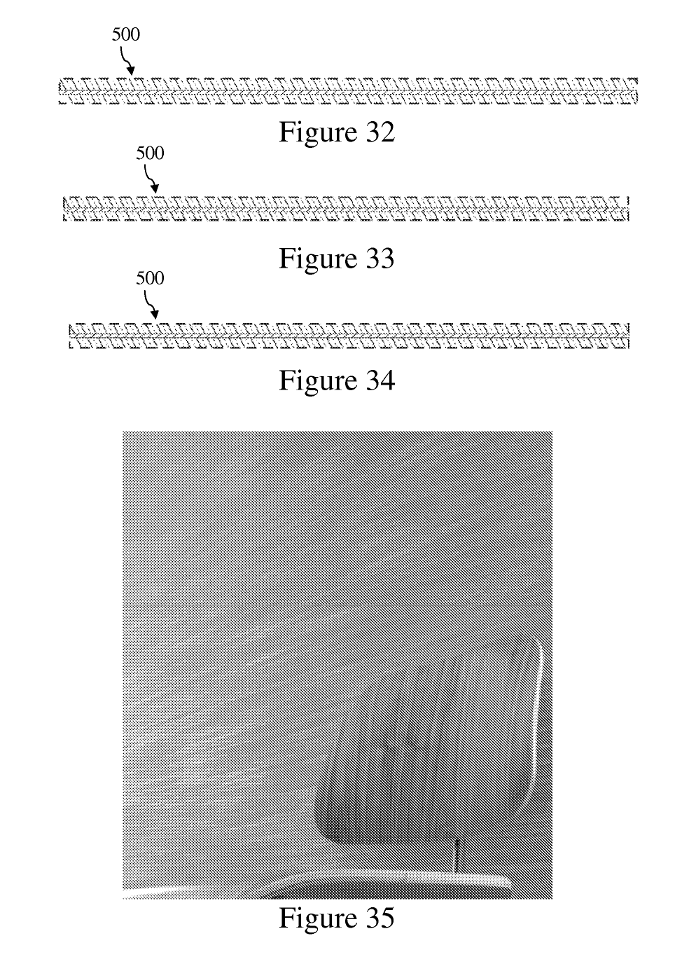

FIGS. 29-34 illustrate various views of another resin-based panel with a fabric interlayer 500. In particular, FIGS. 29-34 illustrate a resin-based panel 500 having a densely woven fabric interlayer 502 having a flowing design. FIG. 35 illustrates a partition formed with a resin-based panel having a densely woven fabric interlayer having a flowing design.

FIGS. 31-34 illustrate that the resin-based panel 500 can include a densely woven fabric interlayer 502 laminated between opposing resin layers 510, 512. In particular, the opposing resin layers 510, 512 can be melted and adhered to the densely woven fabric interlayer 502. In some implementations, the opposing resin layers 510, 512 can extend between the fabric of the densely woven fabric interlayer 502 and bond to each other.

The resin layers 510, 512 can be transparent, translucent, and/or colored. In alternative implementations one of the resin layers 510, 512 can be opaque. In any event at least one of the resin layers 510, 512 can be at least partially transparent to visually expose the fabric interlayer 502. One will appreciate that the gauge or thickness of the resin layers 510, 512 and the fabric interlayer 502 can vary depending upon the desired functional and aesthetic use of the resin-based panel 500.

A manufacturer can form the resin-based panel 400, 500 with fabric interlayer 408, 502 by first creating a lay-up assembly comprising a first transparent resin layer 410, 510 the fabric interlayer 408, 502 and a second transparent resin layer 412, 512. The manufacturer can then apply heat and pressure to cause the resin layers 410, 412, 510, 512 to melt and bond to the fabric interlayer 408, 502. One will appreciate that the manufacturer can apply the heat and pressure in a lamination press, oven, autoclave, or other thermosetting environment.

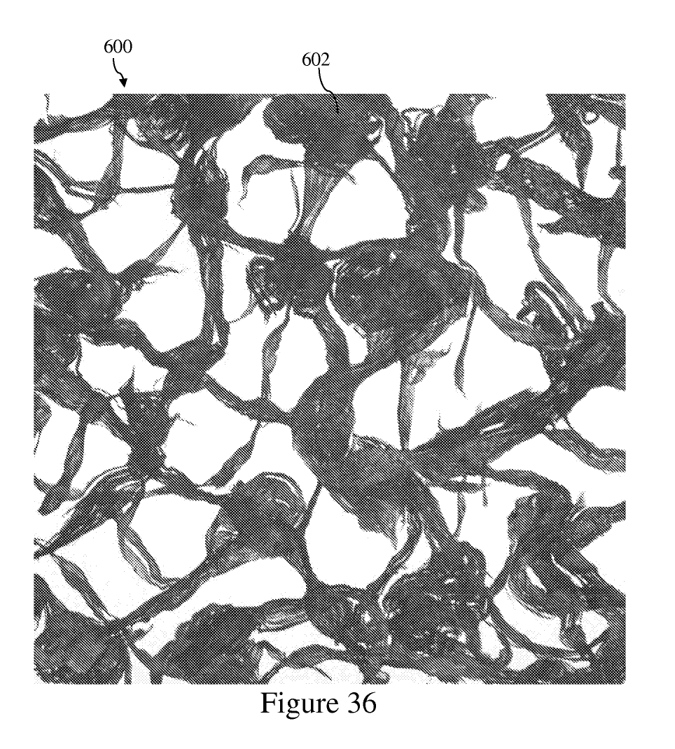

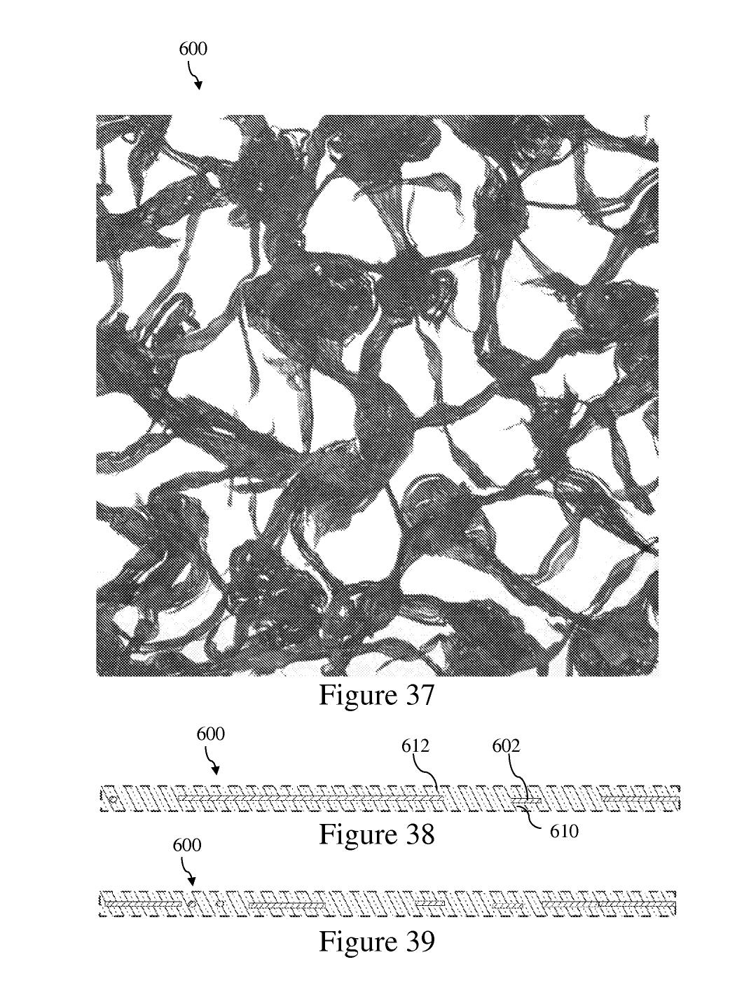

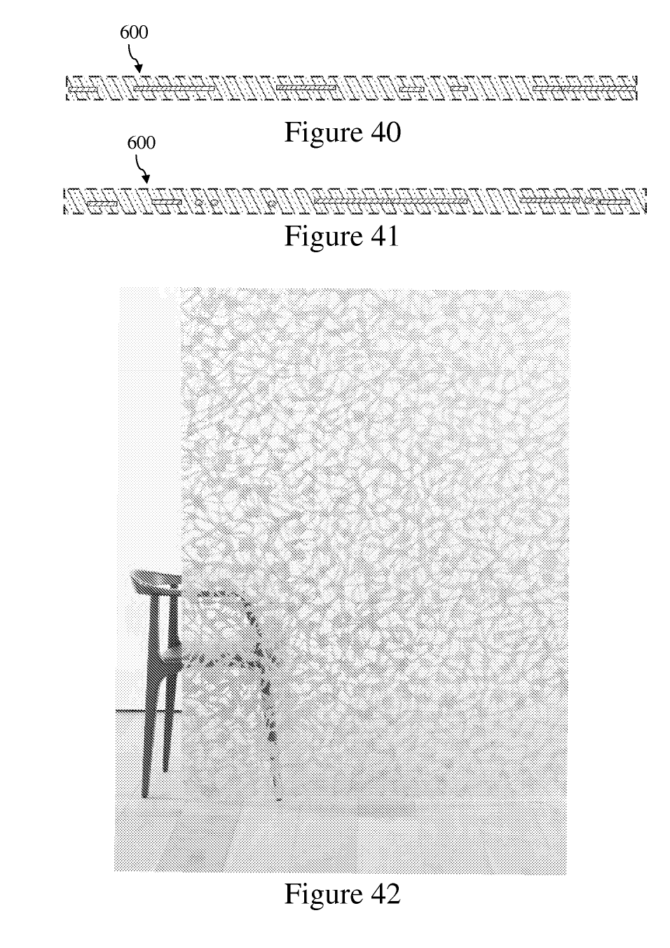

Implementations of the present invention can include decorative image layers other than fabric interlayers. For example, FIGS. 36-41 illustrate various views of another resin-based panel 600 with a decorative image layer laminated between opposing resin layers. In particular, FIGS. 36-41 illustrate a resin-based panel 600 with a handmade paper interlayer having an intertwining design 602. In other words, the paper of the interlayer can bisect and cross over other pieces of paper to create a unique design. One will appreciate that as the paper interlayer 602 is handmade, each panel 600 can include a slightly different design. In one implementation, the handmade paper interlayer can comprise paper made from harvested Lotka bark.

Similar to panels 400 and 500 with fabric interlayers, FIGS. 38-41 illustrate that the resin-based panel 600 can include a handmade paper interlayer 602 laminated between opposing resin layers 610, 612. In particular, the opposing resin layers 610, 612 can be melted and adhered to the handmade paper interlayer 602. Furthermore, the opposing resin layers 610, 612 between the sections of the handmade paper interlayer 602 can also be melted and bonded to each other.

The resin layers 610, 612 can be transparent, translucent, and/or colored. In alternative implementations one of the resin layers 610, 612 can be opaque. In any event at least one of the resin layers 610, 612 can be at least partially transparent to visually expose handmade paper interlayer 602. One will appreciate that the gauge or thickness of the resin layers 610, 612 and handmade paper interlayer 602 can vary depending upon the desired functional and aesthetic use of the resin-based panel 600.

In any case, as shown by FIG. 42, the resin-based panel with a handmade paper interlayer having an intertwining design can be at least partially translucent. In particular, the portions of the panel between the handmade paper interlayer can be transparent. In alternative implementations, the resin-based panel with a handmade paper interlayer can be transparent or opaque. As shown by the partition of FIG. 42, the resin-based panel with a handmade paper interlayer having an intertwining design can provide semi-privacy.

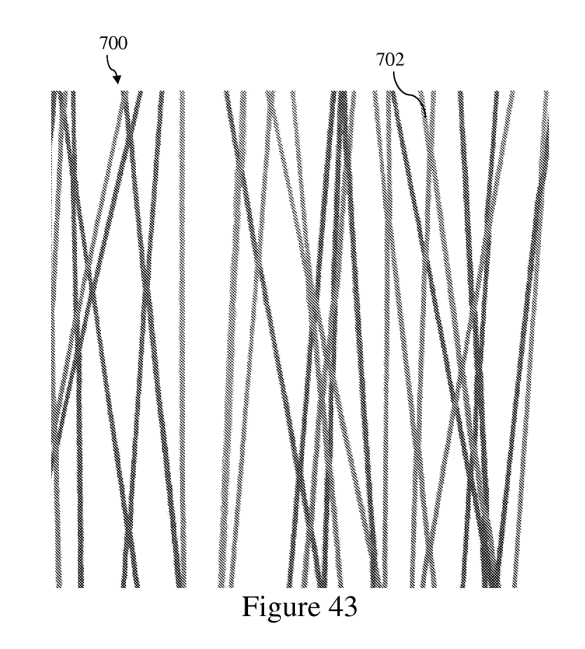

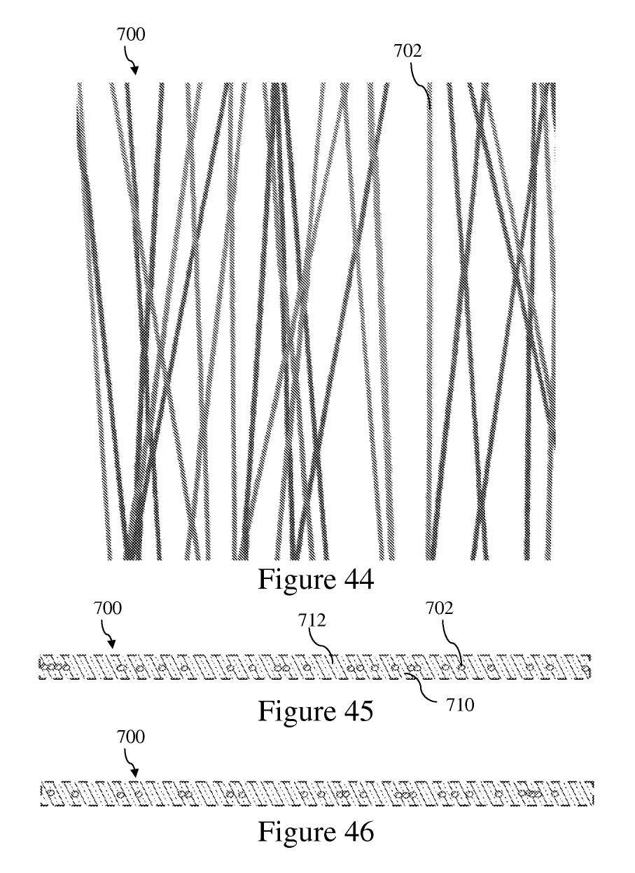

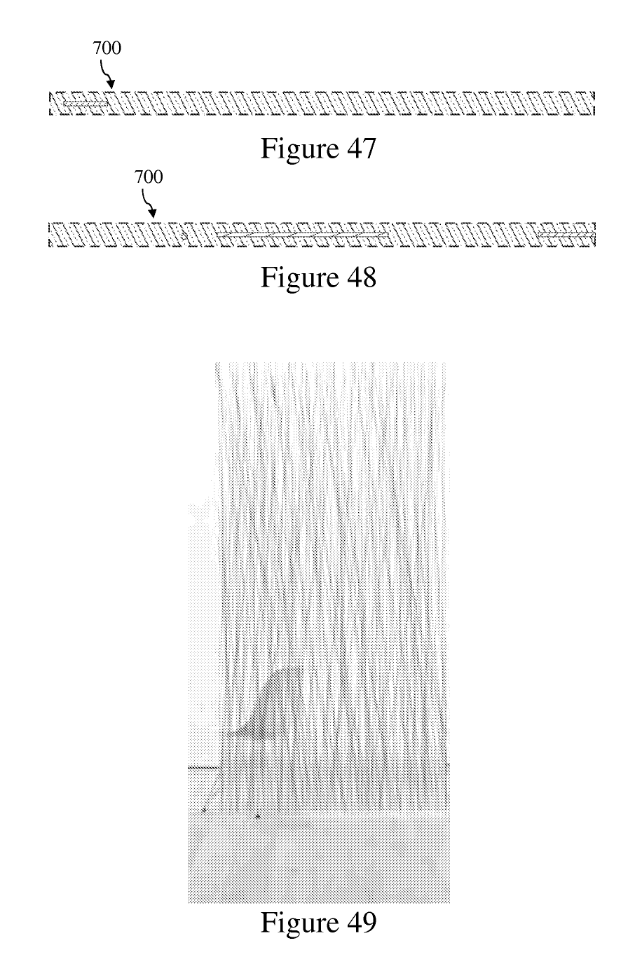

FIG. 43-48 illustrate various views of yet another resin-based panel 700 with a decorative image layer laminated between opposing resin layers. In particular, FIGS. 43-48 illustrate a resin-based panel 700 with an interlayer 702 of spun yarn in a linear formation. In other words, the interlayer 702 can comprise individual pieces of spun yarn aligned in a generally linear formation. As shown by FIGS. 43 and 44, the pieces of spun yarn of the interlayer 702 may not be parallel to each other. In other words, the pieces of spun yarn of the interlayer 702 can cross over and under each other.

Additionally, the pieces of spun yarn of the interlayer 702 can comprise pieces of varying length and thickness. In some implementations, all of the pieces of spun yarn of the interlayer 702 can have the same color. In alternative implementations, the pieces of spun yarn of the interlayer 702 can include varying colors.

FIGS. 45-48 illustrate that the interlayer 702 of spun yarn can be laminated between opposing resin layers 710, 712. In particular, the opposing resin layers 710, 712 can be melted and adhered to and around the pieces of spun yarn of the interlayer 702. Furthermore, the opposing resin layers 710, 712 between the pieces of the interlayer 702 can also be melted and bonded to each other.

Similar to the other resin layers described herein above, the resin layers 710, 712 can be transparent, translucent, and/or colored. In alternative implementations one of the resin layers 710, 712 can be opaque. In any event at least one of the resin layers 710, 712 can be at least partially transparent to visually expose spun yarn interlayer 702. One will appreciate that the gauge or thickness of the resin layers 710, 712 can vary depending upon the desired functional and aesthetic use of the resin-based panel 700.

In any case, as shown by FIG. 49, the resin-based panel with an interlayer 702 of spun yarn in a linear formation can be at least partially translucent. In particular, the portions of the panel between the spun yarn interlayer can be transparent. In alternative implementations, the resin-based panel with an interlayer 702 of spun yarn in a linear formation can be transparent or opaque. As shown by the partition of FIG. 49, the resin-based panel with an interlayer 702 of spun yarn in a linear formation can provide semi-privacy.

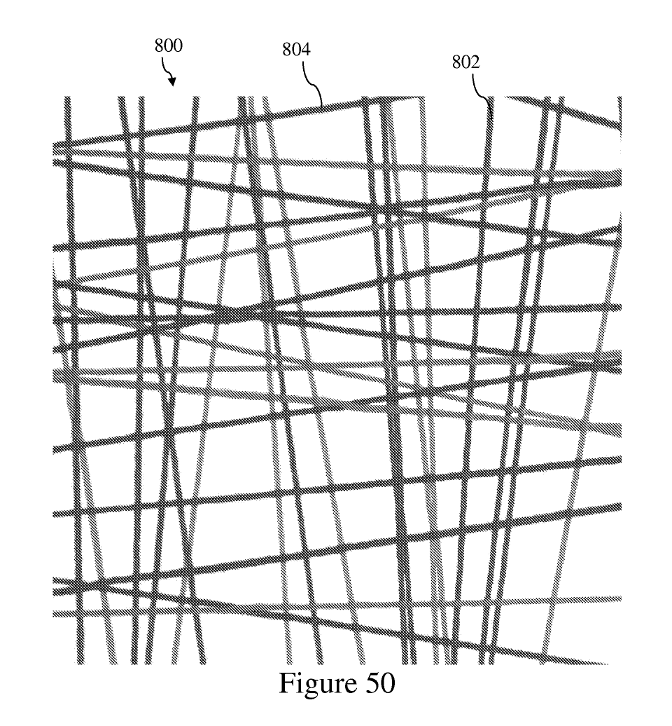

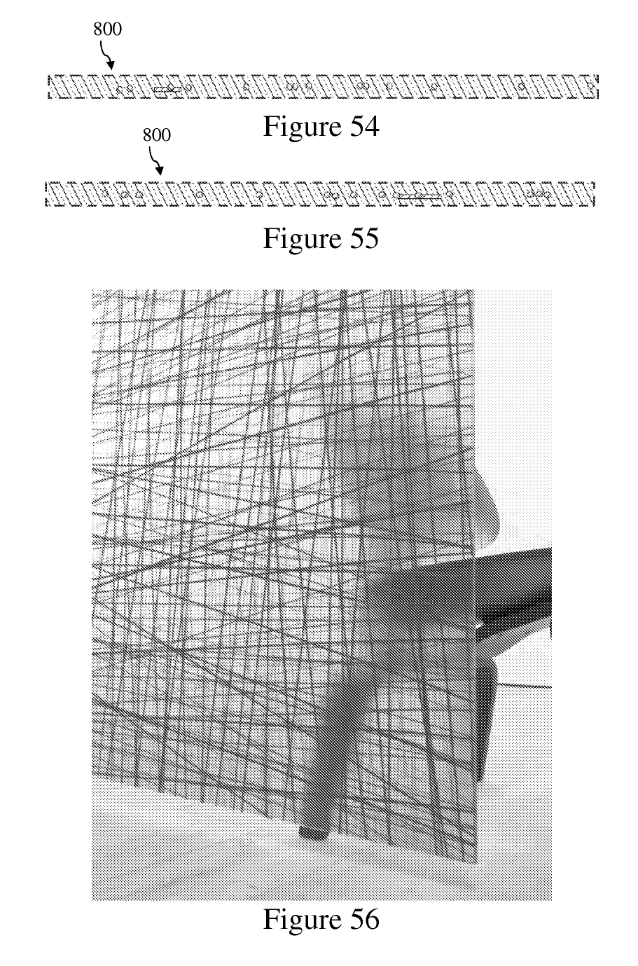

FIGS. 50-55 illustrate various views of another resin-based panel 800 with a decorative image layer of spun yarn. In particular, FIGS. 50-55 illustrate a resin-based panel 800 with an interlayer of spun yarn in a bisecting formation. In other words, the interlayer comprises a first set 802 of individual pieces of spun yarn generally aligned in first direction a substantially linear fashion, and a second set 804 of individual pieces of spun yarn generally aligned in second perpendicular direction. The second set 804 of individual pieces of spun yarn can extend in a generally linear fashion. Thus, the pieces of spun yarn of the first set 802 bisect and cross over or under the pieces of spun yarn of the second set 804.

As shown by FIGS. 50 and 51, the pieces of spun yarn of the first set 802 may not be parallel to each other, and thus, may bisect each other in addition to the pieces of spun yarn of the second set 804. Similarly, the pieces of spun yarn of the second set 804 may not be parallel to each other, and thus, may bisect each other in addition to the pieces of spun yarn of the first set 802. Thus, the pieces of spun yarn of the interlayer 802, 804 can cross over and under each other in a variety of ways.

Additionally, the pieces of spun yarn of the interlayer 802, 804 can comprise pieces of varying length and thickness. In some implementations, all of the pieces of spun yarn of the interlayer 802, 804 can have the same color. In alternative implementations, the pieces of spun yarn of the interlayer 802, 804 can include varying colors.

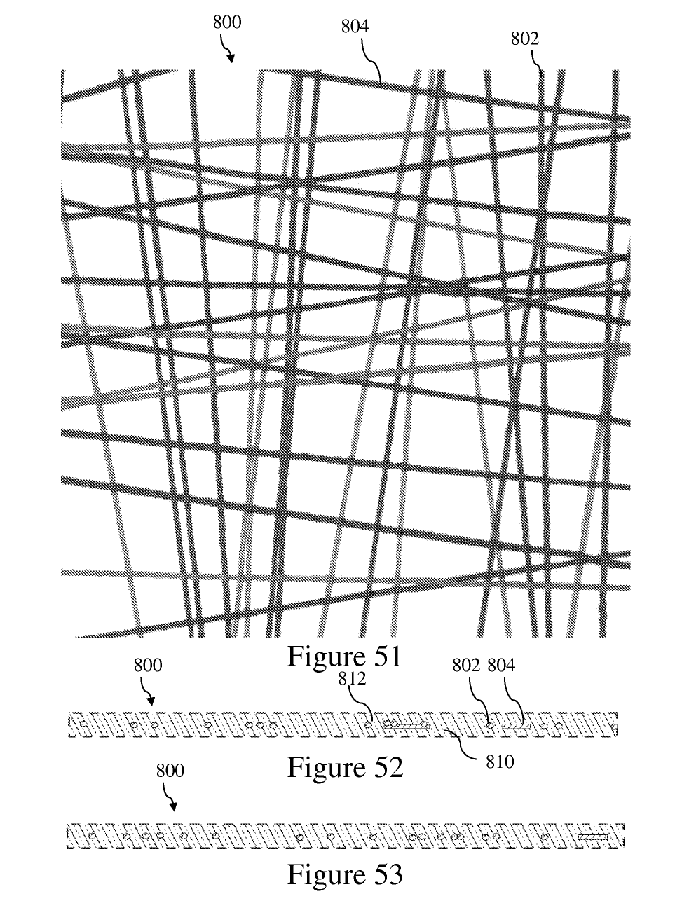

FIGS. 52-55 illustrate that the interlayer 802, 804 of spun yarn can be laminated between opposing resin layers 810, 812. In particular, the opposing resin layers 810, 812 can be melted and adhered to and around the pieces of spun yarn of the interlayer 802, 804. Furthermore, the opposing resin layers 810, 812 between the pieces of the interlayer 802, 804 can be melted and bonded to each other.

Similar to the other resin layers described herein above, the resin layers 810, 812 can be transparent, translucent, and/or colored. In alternative implementations one of the resin layers 810, 812 can be opaque. In any event at least one of the resin layers 810, 812 can be at least partially transparent to visually expose spun yarn interlayer 802, 804. One will appreciate that the gauge or thickness of the resin layers 810, 812 can vary depending upon the desired functional and aesthetic use of the resin-based panel 800.

In any case, as shown by FIG. 56, the resin-based panel 800 with an interlayer 802, 804 of spun yarn in a bisecting formation can be at least partially translucent. In particular, the portions of the panel between the spun yarn interlayer can be transparent. In alternative implementations, the resin-based panel with an interlayer of spun yarn in a bisecting formation can be transparent or opaque. As shown by the partition of FIG. 56, the resin-based panel with an interlayer of spun yarn in a linear formation can provide semi-privacy.

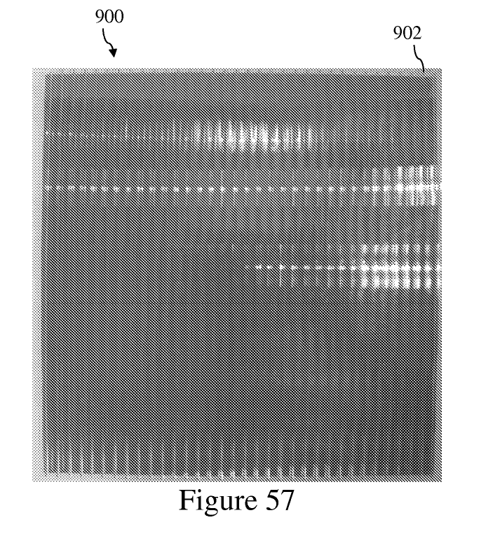

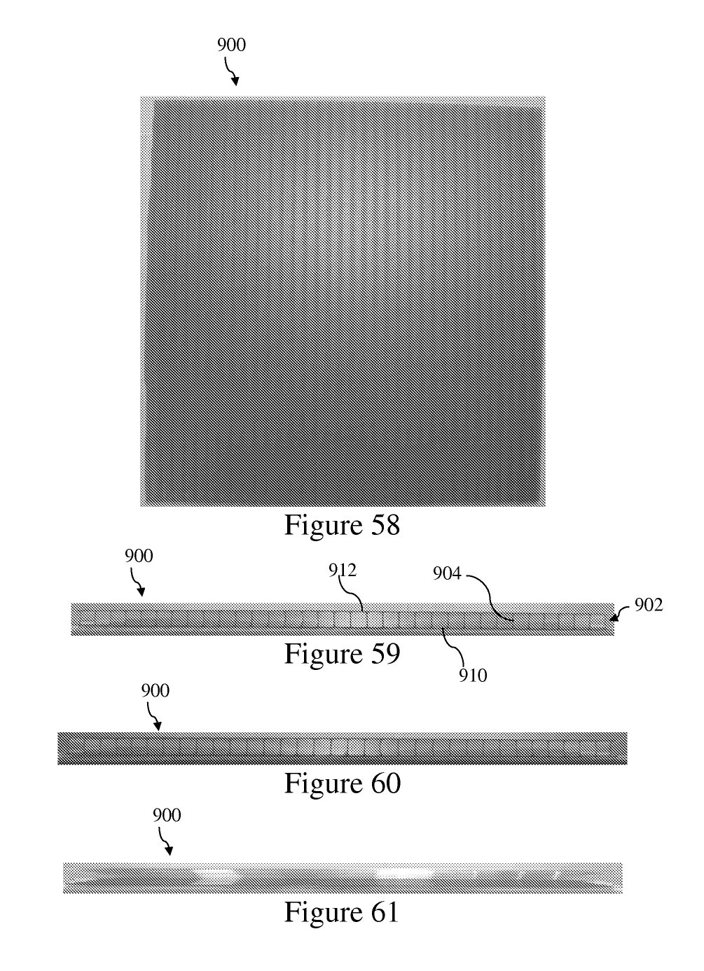

Yet a further implementation of the present invention includes a panel having a square-shaped core laminated between opposing out layers of resin material. For example, FIGS. 57-62 illustrates various views of a resin-based panel having a squared-core 900. In particular, the squared-core can comprise form longitudinally extending cells with a square cross-section.

For example, FIGS. 59 and 60 illustrate top and bottom end views of the resin-based panel having a squared-core 900. As shown by FIGS. 59 and 60, the core 902 can comprise laterally extending walls 904 that extend in a direction generally perpendicular to relative, and between, a lower resin layer 910 and an upper resin layer 912. The walls 904 can define rectangular-shaped cells 914. As shown by FIGS. 59 and 60, in some implementations of the present invention resin-based panel having a squared-core 900 includes a squared core 902 laminated between opposing upper 912 and lower 910 resin substrates. In alternative implementations, however, the resin-based panel having a squared-core 900 can comprise a structured core 902 laminated to a single resin substrate.

Additionally, the resin-based panel having a squared-core 900 shown in FIGS. 57-62 includes single-layered resin substrates 910, 912. One will appreciate, however, that the resin-based panel having a squared-core 900 can alternatively comprise a laminate of multiple resin-based substrates 910, 912 of the same or different materials as those described above. The resin substrates 910, 912 can vary in thickness to include a range from relatively thin gauge films to thicker gauge sheets (e.g., greater than about one-sixteenth inch ( 1/16″) to about 5 inches (5″)).

For example, in some implementations, the gauge of the resin-based panel having a squared-core 900 in at least one implementation can be anywhere from about one-sixteenth inch ( 1/16″) to about two inches (2″) inches. The thickness of resin-based panel having a squared-core 900 can be based at least partially on the number of resin-based substrates it comprises, as well as the desired end-use. Furthermore, when upper 912 and lower 912 resin substrates are used, as in the resin-based panel having a squared-core 900 of FIGS. 57-62, the upper resin substrate 912 can comprise the same thermoplastic materials as the lower resin substrate 910. Alternatively, the upper 912 and lower 910 resin substrates can comprise differing thermoplastic materials.

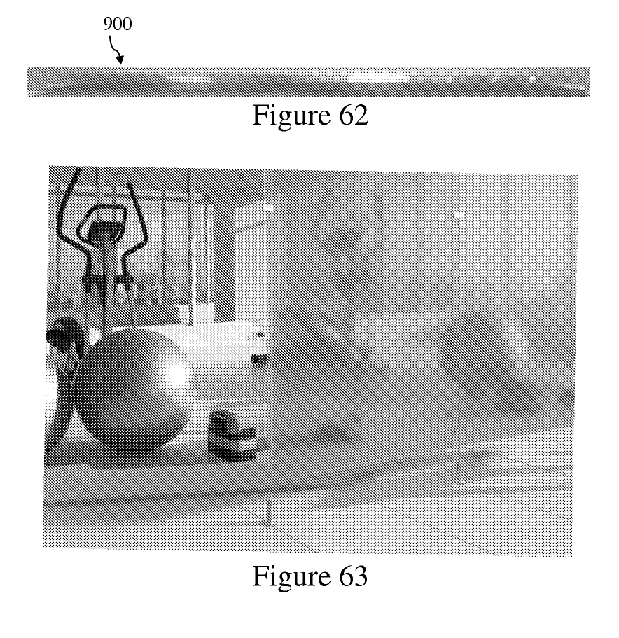

As shown by FIGS. 61 and 62, in some implementations the walls 904 of the squared core 902 and the upper resin substrate 912 can comprise a transparent material. FIGS. 61 and 62 further illustrates that the lower resin substrate 910 can comprise a translucent, but colored material. In alternative implementation, the lower and upper resin substrates 910, 912 and the squared core 902 can comprise opaque materials, all transparent materials, or all translucent materials.

In any event, FIG. 63 illustrates that a manufacturer can use the resin-based panel having a squared-core 900 to form partitions or other structures. Such partitions can divide a room, cover windows, or function as a door. In any event, the resin-based panel having a squared-core 900 can provide varying degrees of privacy depending upon the transparency/translucency of the panels 900.

The present invention may thus be embodied in other specific forms without departing from its spirit or essential characteristics. For example, each of the panels describe herein above has include a single decorative image layer or feature. In alternative implementations, however, the panels of the present invention can include a combination of decorative image layers and/or features. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. An architectural resin-based panel, comprising:
an at least partially translucent resin layer having a front surface and an opposing back surface surrounded by four edges; and
a plurality of linear recesses embossed in the front surface.

2. An architectural resin-based panel, comprising:
an at least partially translucent resin layer having a front surface and an opposing back surface surrounded by four edges; and
a plurality of pebble shaped recesses embossed in the front surface.

3. An architectural resin-based panel, comprising:
an at least partially translucent resin layer having a front surface and an opposing back surface surrounded by four edges; and
a plurality of bubble shaped recesses embossed in the front surface.

4. An architectural resin-based panel, comprising:
a first at least partially translucent resin layer;
a second at least partially translucent resin layer; and
a fabric interlayer positioned between the first and second resin layers, the fabric interlayer having a line and bunch design;
wherein the first and second resin layers are melted and bonded to the fabric interlayer.

5. An architectural resin-based panel, comprising:
a first at least partially translucent resin layer;
a second at least partially translucent resin layer; and
a densely woven fabric interlayer positioned between the first and second resin layers, the densely woven fabric interlayer having a flowing design;
wherein the first and second resin layers are melted and bonded to the fabric interlayer.

6. An architectural resin-based panel, comprising:
a first at least partially translucent resin layer;
a second at least partially translucent resin layer; and
a interlayer of handmade paper positioned between the first and second resin layers, the interlayer of handmade paper having an intertwining design;
wherein the first and second resin layers are melted and bonded to each other and the interlayer of handmade paper.

7. An architectural resin-based panel, comprising:
a first at least partially translucent resin layer;
a second at least partially translucent resin layer; and
a interlayer of spun yarn positioned between the first and second resin layers, the interlayer of spun yarn having an intertwining design;
wherein the first and second resin layers are melted and bonded to each other and the interlayer of spun yarn.

8. An architectural resin-based panel, comprising:
a first at least partially translucent resin layer;
a second at least partially translucent resin layer; and
a interlayer of spun yarn positioned between the first and second resin layers, the interlayer of spun yarn having a bisecting design;
wherein the first and second resin layers are melted and bonded to each other and the interlayer of spun yarn.
